(19) United States
(12) Patent Application Publication
(10) Pub. No.: US 2024/0176274 A1
(43) Pub. Date: May 30, 2024

(54) IMAGE FORMING APPARATUS THAT DECIDES MALFUNCTION, AND MALFUNCTION DECIDING METHOD

(71) Applicant: KYOCERA Document Solutions Inc., Osaka (JP)

(72) Inventors: Jun NAKAI, Osaka (JP); Hideji MIZUTANI, Osaka (JP); Takuto KUNIMASA, Osaka (JP)

(73) Assignee: KYOCERA Document Solutions Inc., Osaka (JP)

(21) Appl. No.: 18/517,032

(22) Filed: Nov. 22, 2023

(30) Foreign Application Priority Data
Nov. 30, 2022 (JP) 2022-191488

(51) Int. Cl. G03G 15/00

(52) U.S. Cl. CPC G03G 15/6567; G03G 2215/0158

(57) ABSTRACT

An image forming apparatus includes an image carrier, an optical member, a drive device, a motive device, and a control device. On a surface of the image carrier, a scanning line is formed, through a scanning operation with scanning light. The optical member emits the scanning light to the image carrier. The drive device changes a posture of the optical member, to adjust a skew of the scanning line on the image carrier. The motive device drives the drive device. The control device controls the motive device. Further, the control device decides that at least one of the drive device and the motive device are malfunctioning, when a skew amount remains higher than a predetermined permissible value, despite changing the posture of the optical member a predetermined number of times, through control of the drive device by the motive device.

### INCORPORATION BY REFERENCE

This application claims priority to Japanese Patent Application No. 2022-191488 filed on Nov. 30, 2022, the entire contents of which are incorporated by reference herein.

### BACKGROUND

The present disclosure relates to an image forming apparatus and a malfunction deciding method.

Nowadays, both high picture quality and high productivity are required, from printers and copiers that output color images. In addition, apparatuses that can output images in high picture quality in an initial stage, are required to maintain the high-quality performance, despite executing consecutive printing operation. In order to maintain the high picture quality, it is critically important to accurately correct printing position shift of each color, in the color image.

Types of the color shift in an optical scanning device include, for example, a color shift arising from a positional shift in main scanning, a positional shift due to difference of magnification of main scanning, a positional shift in sub scanning, a positional shift due to warped scanning, and inclination of a scanning line. Among those, the positional shift in main scanning, the positional shift due to difference of magnification of main scanning, the positional shift in sub scanning, and the positional shift due to warped scanning, can be relatively easily adjusted, through light emission control of the optical scanning device.

For example, the positional shift in main scanning can be easily adjusted, by adjusting light emission timing from a synchronization signal of the optical scanning device. Likewise, the positional shift in sub scanning and the positional shift due to difference of magnification of main scanning, can be easily adjusted by adjusting the light emission timing. In the case of the positional shift due to warped scanning, the adjustment can be easily performed, through temporarily storing the image data in a memory before outputting, and shifting the timing to output the image data in the sub scanning direction, in each of regions divided in the main scanning direction.

The inclined scanning line can also be adjusted, similarly to the adjustment of the warped scanning. However, in general, the adjustment of the inclined scanning line is performed over a wider range, than in the adjustment of the positional shift due to warped scanning. Accordingly, a larger amount of image data has to be stored in the memory, which leads to an increase in cost of the device that performs the light emission control.

Therefore, in the case of the inclined scanning line (hereinafter referred to as “skew”), the adjustment thereof (hereinafter referred to as “skew adjustment”) is performed by rotating an optical member provided in the proximity of a photoconductor body.

For example, an image forming apparatus, configured to rotate an elongate optical member provided in the proximity of the photoconductor body; thereby performing the skew adjustment, has been proposed. This image forming apparatus includes a drive device that transmits motive force to a rotary mechanism for rotating the optical member. Employing a motor as the drive device eliminates the need to depend on human's hands, to rotate the optical member.

In the case where the drive device is not provided, the rotary mechanism has to be driven by human's hands. In this case, however, the operation of the image forming apparatus has to be suspended. Accordingly, the image forming apparatus becomes temporarily unusable, while the skew adjustment is being performed, which leads to degraded productivity of the image forming operation, by the image forming apparatus.

Further, it is necessary to detect the actual skew amount, in order to perform the skew adjustment. Accordingly, an image forming apparatus that detects and adjusts the skew amount has been proposed. In this image forming apparatus, a plurality of linear toner images are formed on an image carrier such an intermediate transfer belt, in both of the main scanning direction and the sub scanning direction. Then the color shift amount of each color, with respect to a reference color, is detected by measuring the position of the linear toner image. The skew amount is calculated by obtaining a difference in color shift amount in the sub scanning direction, detected from the toner images on the respective ends in the main scanning direction. Then the skew is adjusted, by outputting a drive pulse that accords with the skew amount, on the basis of the difference calculated as above, to the drive motor that rotates the optical member.

### SUMMARY

The disclosure proposes further improvement of the foregoing techniques.

In an aspect, the disclosure provides an image forming apparatus including an image carrier, an optical member, a drive device, a motive device, and a control device. On a surface of the image carrier, a scanning line is formed, through a scanning operation with scanning light. The optical member emits the scanning light to the image carrier. The drive device changes a posture of the optical member, to adjust a skew of the scanning line on the image carrier. The motive device drives the drive device. The control device controls the motive device. Further, the control device decides that at least one of the drive device and the motive device is malfunctioning, when a skew amount remains higher than a predetermined permissible value, despite changing the posture of the optical member a predetermined number of times, through control of the drive device by the motive device.

In another aspect, the disclosure provides a malfunction deciding method, to be executed by an image forming apparatus including an image carrier on a surface of which a scanning line is formed, through a scanning operation with scanning light, an optical member that emits the scanning light to the image carrier, a drive device that changes a posture of the optical member, to adjust a skew of the scanning line on the image carrier, and a motive device that drives the drive device. The method includes deciding that at least one of the drive device and the motive device is malfunctioning, when a skew amount remains higher than a predetermined permissible value, despite changing the posture of the optical member a predetermined number of times, through control of the drive device by the motive device.

### BRIEF DESCRIPTION OF THE DRAWINGS

FIG. 1 is a schematic perspective view showing a configuration of an essential part of an image forming apparatus according to an embodiment of the disclosure:

FIG. 2 is an enlarged perspective view showing a motor for skew adjustment shown in FIG. 1:

FIG. 3 is a schematic diagram showing an example of a color shift detection pattern drawn on an intermediate transfer belt: and

FIG. 4 is a flowchart showing an operation performed by the image forming apparatus according to the embodiment of the disclosure.

### DETAILED DESCRIPTION

Hereafter, an image forming apparatus and a malfunction deciding method according to an embodiment of the disclosure will be described, with reference to the drawings. In the drawings, the same or corresponding elements will be given the same numeral, and the description of such elements will not be repeated.

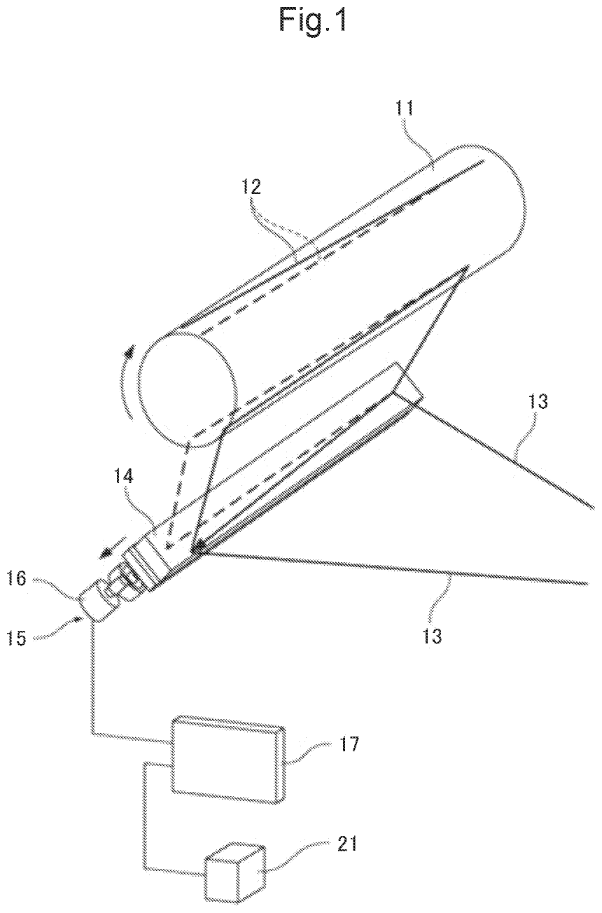

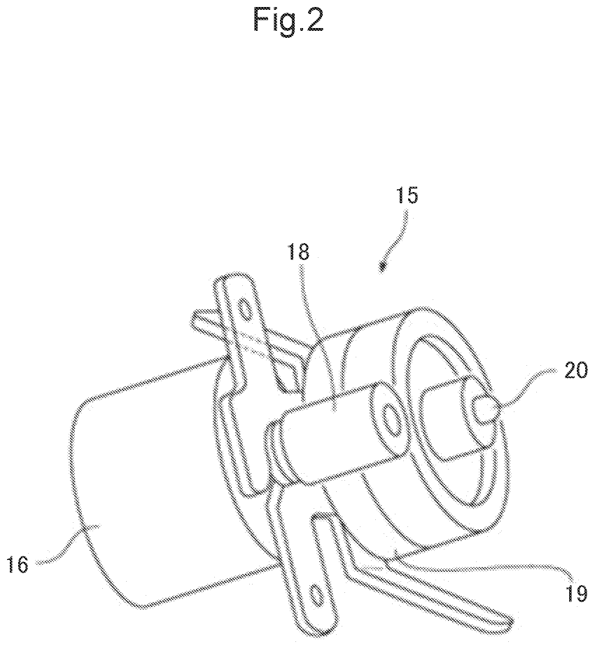

FIG. 1 is a schematic perspective view showing a configuration of an essential part of the image forming apparatus according to the embodiment. FIG. 2 is an enlarged perspective view showing a motor for skew adjustment shown in FIG. 1.

FIG. 1 illustrates a photoconductor drum 11, exemplifying the image carrier in the image forming apparatus according to the embodiment. The photoconductor drum 11 has the surface thereof scanned by scanning light 13 from an optical member 14. The line formed on the surface of the photoconductor drum 11, by the scanning with the light 13 will be referred to as a scanning line 12. The optical member 14, having a mirror structure to reflect the scanning light 13 toward the photoconductor drum 11, is located in the proximity of the photoconductor drum 11. The optical member 14 is configured to change the posture, by being driven by a drive device 15. Examples of the changes in posture of the optical member 14 will be subsequently described.

The drive device 15 includes a motor (motive device)16, serving as the drive source for the drive device 15. When the motor 16 rotates forward or backward, the drive device 15 changes the posture of the optical member 14, so as to adjust the skew of the scanning line on the photoconductor drum 11. The rotation of the motor 16 is controlled by a control device 17. The control device 17 serves to control the operation of the image forming apparatus. The control device 17 includes a processor, a random-access memory (RAM), and a read-only memory (ROM). The processor is, for example, a central processing unit (CPU), an application specific integrated circuit (ASIC), or a micro processing unit (MPU). The control device 17 is configured to control the operation of each component of the image forming apparatus, when the processor executes a control program stored in the storage device, such as the ROM.

Referring to FIG. 1 and FIG. 2, a configuration of the drive device 15 will be described hereunder. The basic configuration is similar to that of a device disclosed in Japanese Patent Publication No. 4948042. The motor 16 is a simple stepping motor. Around a rotary drive shaft 18 of the motor 16, a gear with an oblique groove is attached, so as to rotate interlocked with the rotary drive shaft 18.

Another gear 19 is provided close to the gear on the rotary drive shaft 18, so as to be meshed with the gear. The groove on the gear 19 is formed such that, when the rotary drive shaft 18 rotates, thereby causing the gear 19 meshed with the gear on the rotary drive shaft 18 to rotate, the gear 19 advances in the direction in which the rotary drive shaft 18 extends. Accordingly, when the motor 16 rotates, a protrusion 20 located on the rotary shaft of the gear 19 moves in the direction in which the rotary drive shaft of the gear 19 extends.

The distal end portion of the protrusion 20 is in contact with the side face of the optical member 14 on the opposite side of the mirror reflection surface, at a position close to an end portion in the longitudinal direction of the optical member 14. When the rotary drive shaft 18 of the motor 16 rotates in a predetermined direction, the gear 19 and the protrusion 20 are moved toward the optical member 14. Accordingly, the end portion of the optical member 14 is pushed by the protrusion 20, so that the optical member 14 is rotated about a fulcrum provided at a generally central position in the longitudinal direction, such that the end portion comes closer to the photoconductor drum 11, and the other end portion moves in the direction away from the photoconductor drum 11. Here, the first mentioned end portion of the optical member 14 is biased toward the motor 16.

In contrast, when the rotary drive shaft 18 of the motor 16 rotates oppositely to the predetermined direction, the gear 19 and the protrusion 20 move in the direction away from the optical member 14. At this point, the protrusion 20 no longer presses the end portion of the optical member 14, and the optical member 14 rotates about the fulcrum such that the end portion moves away from the photoconductor drum 11, and that the other end portion comes closer to the photoconductor drum 11.

As described above, the optical member 14, constituted of a fold mirror, is displaced in the direction corresponding to a direction perpendicular to the mirror reflection surface (direction toward and away from the photoconductor drum 11). Thus, the end portion and the other end portion of the mirror reflection surface of the optical member 14 can be moved toward or away from the light 13 emitted from the light source. Such movement allows the incident angle of the light 13 to the mirror reflection surface of the optical member 14 to be changed, thereby enabling the adjustment of the skew of a scanning line 12 on the surface of the photoconductor drum 11, formed as result of the scanning of the surface of the photoconductor drum 11, by the light 13 reflected by the mirror reflection surface.

When the light 13 is incident on the mirror reflection surface of the optical member 14 as indicated by solid lines in FIG. 1, and the scanning direction of the light 13 is not parallel to the longitudinal direction of the mirror reflection surface, in other words when the scanning direction of the light 13 is inclined with respect to the longitudinal direction of the mirror reflection surface, the control device 17 controls the motor 16 with an adjustment amount based on a drive pulse to be subsequently described, so as to rotate the rotary drive shaft 18 of the motor 16 oppositely to the predetermined direction. Accordingly, the protrusion 20 is kept from pressing the end portion of the optical member 14, and therefore the optical member 14 is made to rotate about the fulcrum, such that the end portion moves away from the photoconductor drum 11. Thus, the incident angle of the light 13 to the mirror reflection surface is changed, such that the light 13 becomes incident on the mirror reflection surface so as to scan at the position indicated by broken lines in FIG. 1. Through such a process, the adjustment of the inclination (skew adjustment) of the scanning line 12 on the surface of the photoconductor drum 11 can be performed.

The image forming apparatus shown in FIG. 1 includes a non-illustrated intermediate transfer belt for transferring a toner image created on the basis of a latent image formed on the photoconductor drum 11. In addition, the image forming apparatus shown in FIG. 1 includes a color shift detection pattern reading sensor 21, that reads a color shift detection pattern drawn on the intermediate transfer belt. The control device 17 calculates the skew amount, on the basis of a detection result from the color shift detection pattern reading sensor 21. The color shift detection pattern reading sensor 21 is, for example, a density sensor including an optical sensor, having a light emitter and a photodetector. The light emitter emits light to the intermediate transfer belt, and the photodetector detects the amount of the reflected light. Since the amount of the reflected light, received by the photodetector, varies depending on the density on the reflecting surface of the intermediate transfer belt, the control device 17 detects the color shift detection pattern, and the position thereof on the intermediate transfer belt, on the basis of the received light amount outputted from the photodetector.

For example, a calculation method according to Japanese Patent Publication No. 4948042 may be adopted as the calculation method of the skew amount by the control device 17. Therefore, such method will not be described herein in detail. The outline of the method is as described hereunder.

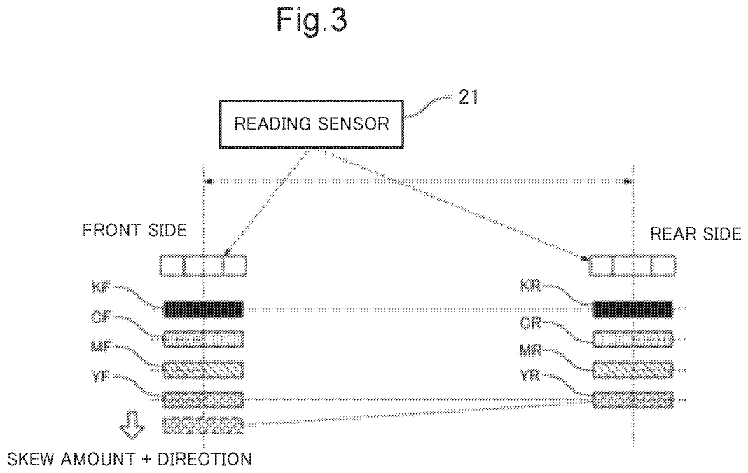

FIG. 3 is a schematic diagram showing an example of the color shift detection pattern drawn on the intermediate transfer belt.

Linear toner images (color shift detection patterns) of the respective colors on the respective end portions in the main scanning direction are formed on the intermediate transfer belt, and the color shift detection pattern reading sensor 21 such as the density sensor reads each of the color shift detection patterns. Then the control device 17 detects the color shift detection patterns and the positions thereof on the intermediate transfer belt, on the basis of the detection result outputted from the color shift detection pattern reading sensor 21, and detects the color shift amount with respect to black (K) which is the reference color, of other colors namely cyan(C), magenta(M), and yellow(Y), from the detection result.

Detection distances between the toner images are defined as under.
Between KF-CF: CKF
Between CF-MF: MCF
Between MF-YF: YMF
Between KR-CR: CKR
Between CR-MR: MCR
Between MR-YR: YMR

The code “F” accompanying each pattern indicates the front side in FIG. 3, and “R” indicates the rear side in FIG. 3.

The skew amount of each color can be calculated as follows, by the control device 17.

Skew C=CKF−CKR

Skew M=Skew C+(MCF−MCR)

Skew Y=Skew M+(YMF−YMR)

The control device 17 outputs a drive pulse for driving the motor 16 for skew adjustment, constituted of a stepping motor, on the basis of the skew amount calculated as above, to the motor 16.

When a skew amount that the motor 16 for skew adjustment, constituted of the stepping motor, can adjust with a single drive pulse, is defined as ΔX (minimum resolution of skew adjustment), the number of drive pulses to be outputted by the control device 17 to the motor can be expressed as Skew C/AX.

The basic operation of the optical member 14, for performing the skew adjustment by changing the posture, is as described above. After the skew adjustment is performed, a color shift due to difference of magnification, or a color shift in the main scanning or sub scanning may take place, in which case the control device 17 again performs the corresponding adjustment, other than the skew adjustment.

Hereunder, a method to decide that the motor 16 for skew adjustment has failed, and is not normally working, will be described. In the image forming apparatus according to this embodiment, the control device 17 decides that at least one of the drive device 15 and the motor 16 is malfunctioning, when a predetermined skew amount is unable to be reached, after the adjustment of the inclination of the scanning line is performed a predetermined number of times. In other words, the control device 17 detects that at least one of the drive device 15 and the motor 16 is malfunctioning.

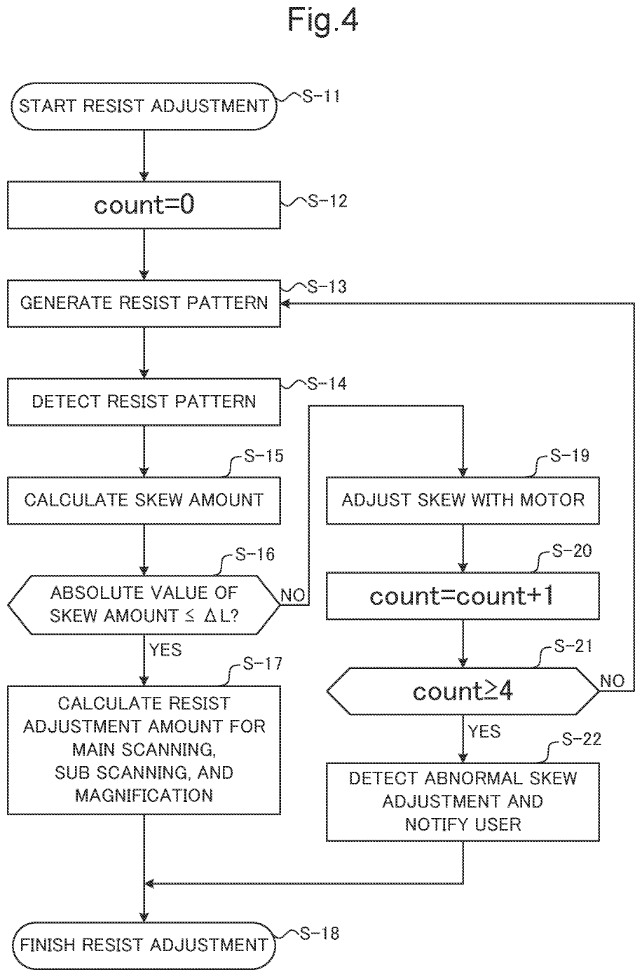

A control process for deciding whether the motor 16 for skew adjustment is malfunctioning is shown in FIG. 4. FIG. 4 is a flowchart showing an operation performed by the image forming apparatus according to this embodiment.

Referring to FIG. 4, when the adjustment of resist, to be used for the decision of the malfunction, is started (step S-11), the control device 17 initializes the count of a loop counter at step S-12. In other words, the count is set to zero.

Then the control device 17 causes the image forming device to generate, at the same time as generating the resist pattern in the sub scanning direction as shown in FIG. 3, a non-illustrated resist pattern for detecting the color shift amount in the main scanning direction, on the intermediate transfer belt (step S-13), and causes the color shift detection pattern reading sensor 21 to detect the color shift amount with respect to the reference color (step S-14). The control device 17 calculates the skew amount, on the basis of the detection result (step S-15). At step S-16, the control device 17 decides whether the absolute value of the calculated skew amount is smaller than a predetermined permissible value ΔL.

When the absolute value of the skew amount is equal to or smaller than the permissible value, the control device 17 decides that the skew adjustment is unnecessary. Accordingly, at step S-17, the control device 17 calculates the resist adjustment amount for the main scanning, the sub scanning, and the magnification, thereby performing the resist adjustment. At this point, the resist adjustment is finished (step S-18).

In contrast, when the control device 17 decides at step S-16 that the absolute value of the skew amount exceeds the permissible value ΔL, the skew adjustment has to be performed. In this case, the control device 17 calculates the skew amount as described above, and calculates the number of drive pulses to be outputted from the motor 16 for skew adjustment, on the basis of the skew amount, to thereby perform the skew adjustment with the calculated drive pulses (step S-19). After performing the skew adjustment at step S-19, the control device 17 increases the count by one at step S-20. The control device 17 checks whether the count has reached a predetermined number of times (four times in the example of FIG. 4). When the count is equal to or fewer than three, the control device 17 returns to step S-13 to again generate the resist pattern, and again detect the skew amount at step S-15.

In the case where the absolute value of the skew amount does not reach the permissible value ΔL, despite the skew adjustment having been performed four times, in other words the skew amount has not been sufficiently improved, the control device 17 decides that at least one of the motor 16 for skew adjustment and the drive device 15 is malfunctioning. Upon making such decision, the control device 17 notifies the occurrence of the malfunction, to the user (step S-22). At this step, for example, the control device 17 causes a display device of the image forming apparatus to display a message urging the user to repair the motor 16 for skew adjustment, or the drive device 15. Thereafter, the operation is finished (step S-18).

At step S-22, the control device 17 is scheduled to notify the occurrence of the malfunction to the user. However, even when the skew adjustment is unable to be performed, in the case where an instruction not to suspend the operation of the image forming apparatus is inputted by the user to the operation device of the image forming apparatus, the control device 17 may skip the checking of the absolute value of the skew amount with respect to the permissible value (step S-16 in flowchart of FIG. 4), and perform the resist adjustment for the main scanning, the sub scanning, and the magnification.

In the flowchart of FIG. 4, the permissible value ΔL of the absolute value of the skew amount may be set as follows.

The permissible value of the skew amount is larger than the minimum resolution of the skew adjustment, realized by the motor 16. In other words, the skew amount is unable to be performed in an increment smaller than the minimum resolution, and therefore the permissible value ΔL is set to a value larger than the minimum resolution ΔX of the motor 16 (ΔX<ΔL).

Alternatively, the permissible value ΔL may be set as follows. The image forming apparatus may further include a detection device for detecting the skew on the photoconductor drum 11, and the permissible value of the skew amount may be set to a value larger than repeated detection accuracy of the detection device. In this case, the repeated measurement accuracy of the skew amount is experimentally confirmed in advance, and defined as β. Basically, the absolute value of the skew amount is unable to be below the repeated measurement accuracy β, and therefore the permissible value ΔL may be set so as to satisfy β <ΔL. For example, 3σ=β may be adopted, where σ represents the standard deviation, in other words β is three times as large as the standard deviation.

In this embodiment, an elongate fold mirror is employed as the optical member 14 to perform the skew adjustment. However, adopting changing the posture of an elongate scanning optical lens (what is known as fθ lens), instead of the fold mirror, also provides the same effect.

The image forming apparatus according to this embodiment includes the color shift detection pattern reading sensor 21, the motor 16, the drive device 15, and the control device 17, which are provided in many of the existing image forming apparatuses, and properly performs the skew adjustment with high accuracy; using the mentioned components without employing an additional mechanism. In addition, the image forming apparatus according to this embodiment decides whether the drive device 15 or the motor 16 for skew adjustment is malfunctioning, when the skew amount is unable to be sufficiently improved, and therefore the skew adjustment and the decision of the malfunction can both be performed, without incurring an increase in manufacturing cost.

Further, setting the permissible value of the skew amount to a value larger than the minimum resolution of the skew adjustment, or than the repeated measurement accuracy in the detection of the skew amount, enables the skew adjustment to be accurately performed, and also enables the decision that the no further skew adjustment can be performed, thereby allowing the user to correctly recognize that the skew adjustment has been performed to a best possible extent.

When the motor for skew adjustment is employed to rotate the optical member, the motor for skew adjustment may fail and become unable to rotate the optical member. However, regarding the existing image forming apparatus, no reference is made to the measures to be taken when the motor for skew adjustment fails and becomes non-operative.

In addition, no detection device has been proposed that again forms a toner image and detects the skew amount, after the skew adjustment is performed by rotating the optical member. The existing detection device is unable to rotate the optical member, when the motor for skew adjustment is damaged or broken. Moreover, the image forming apparatus is unable to detect that the motor for skew adjustment has failed, and therefore the color shift is left uncorrected, which leads to degradation in picture quality.

In order to make it possible to detect that the motor for skew adjustment itself has failed, for example a control driver and a Hall sensor have to be provided on the drive substrate of the motor for skew adjustment, to monitor the rotation status. In this case, a simple and inexpensive stepping motor can no longer be employed, which inevitably leads to an increase in cost.

According to the foregoing embodiment, however, when the motor for skew adjustment, or the drive device that drives the optical member with the drive malfunctions, such malfunction can be easily detected, without the need to employ a drive substrate for the motor for skew adjustment having a complicated structure, for example including the control driver and the Hall sensor.

The embodiment of the disclosure has been described as above, with reference to the drawings. However, the disclosure is not limited to the foregoing embodiment, but may be modified in various manners, without departing from the scope of the disclosure. The drawings each schematically illustrate the elements for the sake of clarity, and the thickness, length, number of pieces, and interval of the illustrated elements may be different from the actual ones, because of the convenience in making up the drawings. Further, the material, shape, and size of the elements referred to in the foregoing embodiment are merely exemplary and not specifically limited, and may be modified as desired, without substantially departing from the configuration according to the disclosure.

### INDUSTRIAL APPLICABILITY

The disclosure provides the image forming apparatus and the malfunction deciding method, and is therefore industrially applicable.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image carrier on a surface of which a scanning line is formed, through a scanning operation with scanning light;
an optical member that emits the scanning light to the image carrier;
a drive device that changes a posture of the optical member, to adjust a skew of the scanning line on the image carrier;
a motive device that drives the drive device; and
a control device that controls the motive device,
wherein the control device decides that at least one of the drive device and the motive device is malfunctioning, when a skew amount remains higher than a predetermined permissible value, despite changing the posture of the optical member a predetermined number of times, through control of the drive device by the motive device.

2. The image forming apparatus according to claim 1, further comprising a color shift detection pattern reading sensor for reading a color shift detection pattern drawn on an intermediate transfer belt,
wherein the control device calculates the skew amount on a basis of a detection result from the color shift detection pattern reading sensor.

3. The image forming apparatus according to claim 1,
wherein the permissible value of the skew amount is larger than a minimum resolution of skew adjustment by the motive device.

4. The image forming apparatus according to claim 1, further comprising a detection device that detects the skew on the image carrier,
wherein the permissible value of the skew amount is larger than repeated detection accuracy of the detection device.

5. A malfunction deciding method to be executed by an image forming apparatus including:
an image carrier on a surface of which a scanning line is formed, through a scanning operation with scanning light;
an optical member that emits the scanning light to the image carrier;
a drive device that changes a posture of the optical member, to adjust a skew of the scanning line on the image carrier; and
a motive device that drives the drive device,
the method comprising deciding that at least one of the drive device and the motive device is malfunctioning, when a skew amount remains higher than a predetermined permissible value, despite changing the posture of the optical member a predetermined number of times, through control of the drive device by the motive device.

6. The malfunction deciding method to be executed by the image forming apparatus according to claim 5, further comprising setting the permissible value of the skew amount, to a value larger than a minimum resolution of skew adjustment by the motive device.

7. The malfunction deciding method to be executed by the image forming apparatus according to claim 5, further comprising setting the permissible value of the skew amount, to a value larger than repeated detection accuracy of a detection device that detects the skew on the image carrier.
